(19) United States
(12) Patent Application Publication
(10) Pub. No.: US 2012/0076620 A1
(43) Pub. Date: Mar. 29, 2012

(54) AUXILIARY FEED-IN MECHANISM

(75) Inventors: Huang-Sheng Chiu, Longtan Township (TW); Hsiu-Wei Lee, Longtan Township (TW); Chi-Feng Lin, Longtan Township (TW)

(73) Assignee: INSTITUTE OF NUCLEAR ENERGY RESEARCH, ATOMIC ENERGY COUNCIL, EXECUTIVE YUAN, Longtan Township (TW)

(21) Appl. No.: 13/246,099

(22) Filed: Sep. 27, 2011

(30) Foreign Application Priority Data
Sep. 28, 2010 (TW) 099132798

(51) Int. Cl. B65G 47/04

(52) U.S. Cl. 414/222.01

(57) ABSTRACT

An auxiliary feed-in mechanism comprises a base having two rails on two sides of the base respectively and a crossrod across two rails on another side of the base; a driving mechanism having a dynamic retractable rod and a chassis, one end of the dynamic retractable rod hinging with one side of the crossrod, another end of the dynamic retractable rod connecting to one side of the chassis, the chassis setting on two rails; a power mechanism setting under the chassis, a driving shaft of the power mechanism penetrating the chassis to expose above the chassis; a delivering mechanism having a frame and a plurality of rollers, the rollers setting side by side in the frame, the delivering mechanism setting above the chassis, a bottom of the frame connecting to the driving shaft, the auxiliary feed-in mechanism can increase the working efficiency of the examining mechanism.

### CROSS-REFERENCE TO RELATED APPLICATION

This non-provisional application claims priority under 35 U.S.C. §119(a) on Patent Application No(s). 099132798 filed in Taiwan, R.O.C. on Sep. 28, 2010, the entire contents of which are hereby incorporated by reference.

### FIELD OF THE INVENTION

The present invention relates to an auxiliary feed-in mechanism, in particular to the auxiliary feed-in mechanism capable of improving the efficiency of operating an examining mechanism.

### BACKGROUND OF THE INVENTION

In general, many industrial operation procedures need to load a material, and one of the loading objects is to feed the material or simply examine the material. The material to be examined must be loaded into an examining machine and then removed from the examining machine after the examination is finished, and then another material to be examined is loaded.

However, a discharge control procedure for a radioactive operation site or a nuclear power plant requires numerous material examinations of the radioactive solid wastes packed in the 55 gallon barrels. An improvement on the procedure is favorable.

In a conventional material examination operation, the feed-in method generally uses a forklift or any other transportation carrier to transport the material to be examined to a feeding inlet of the examination machine, and the examined material is exited from the same feeding inlet, and then the forklift or other transportation carrier is used for removing the examined material. The aforementioned procedure is repeated, and another material to be examined is transported to the examining machine.

As science and technology advance rapidly, the development of the examining machines has shortened the examination time significantly. However, the conventional feeding method still needs to wait for the examined material to be removed by the transporting carrier as described above before another material to be examined can be delivered by the transporting carrier (one material is removed before the other one is fed) to carry out the feeding/unloading procedure. As a result, the overall examination procedure wastes too much time. Of course, the quantity of transporting carriers can be increased to reduce the waiting time caused by the material transportation, but the increase of transporting carriers not only wastes energy and increases costs, but also requires a larger working space.

Therefore, it is a main subject for the present invention to provide an auxiliary feed-in mechanism capable of improving the operating efficiency of an examining mechanism.

### SUMMARY OF THE INVENTION

In view of the shortcomings of the conventional feed-in methods, the inventor of the present invention based on years of experience in the related industry to conduct extensive researches and experiments, and finally developed an auxiliary feed-in mechanism in accordance with the present invention, in hope of achieving the effect of improving the working efficiency of the examining mechanism.

It is a primary objective of the present invention to provide an auxiliary feed-in mechanism, wherein a desired material is placed on a delivering mechanism, and the delivering mechanism is operated together with a driving mechanism and a power mechanism to load or unload the material to achieve the effects of increasing the speed of transporting and exchanging the material, reducing the waiting time of the transportation, and improving the examining mechanism of the working efficiency.

To achieve the foregoing objective, the present invention provides an auxiliary feed-in mechanism to assist feeding an examining mechanism, and the auxiliary feed-in mechanism comprises: a base, having a rail disposed on two sides of the base separately, and a crossrod installed on another side of the base and across the two rails; a driving mechanism, having a dynamic retractable rod and a chassis, and an end of the dynamic retractable rod being pivotally coupled to a side of the crossrod, and another end of the dynamic retractable rod being coupled to a side of the chassis, and the chassis being movably mounted on the two rails; a power mechanism, installed at the bottom of the chassis, and having a drive shaft penetrating through the chassis and being exposed from the top of the chassis; and a delivering mechanism, having a frame and a plurality of rollers, and the rollers being arranged in parallel with one another and pivotally installed in the frame, and the delivering mechanism being installed at the top of the chassis, and the bottom of the frame being coupled to the drive shaft.

Therefore, the auxiliary feed-in mechanism of the present invention can improve the working efficiency of an examining mechanism.

### BRIEF DESCRIPTION OF THE DRAWINGS

FIG. 1 is an exploded view of a preferred embodiment of the present invention;

FIG. 2 is a perspective view of a preferred embodiment of the present invention; and

FIGS. 3 to 12 are schematic views of an application in accordance with a preferred embodiment of the present invention.

### DETAILED DESCRIPTION OF THE PREFERRED EMBODIMENTS

The objects, characteristics and effects of the present invention will become apparent with the detailed description of the preferred embodiments and the illustration of related drawings as follows.

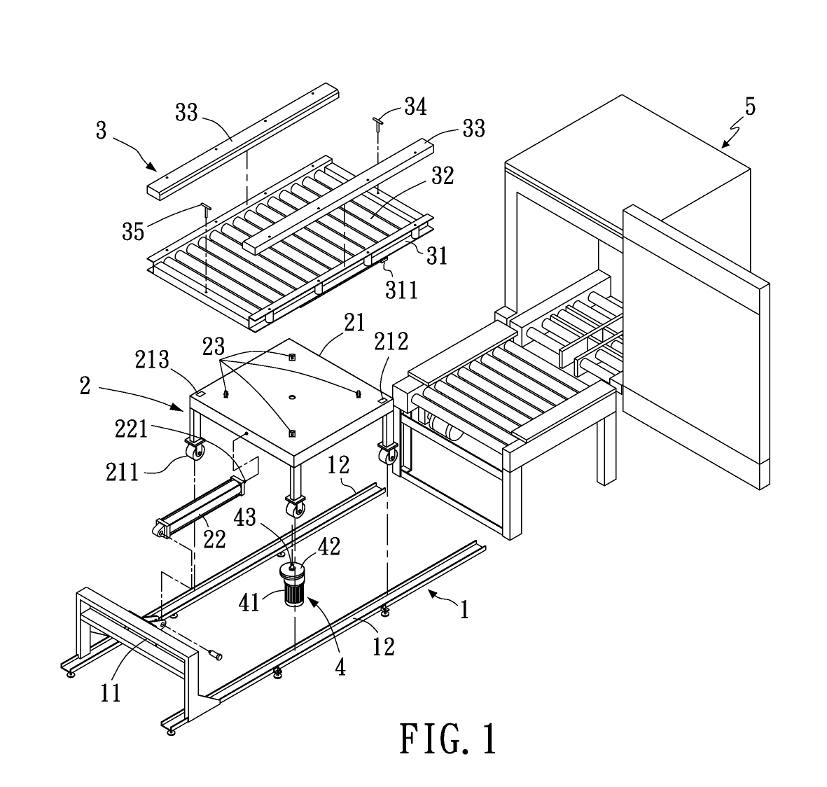

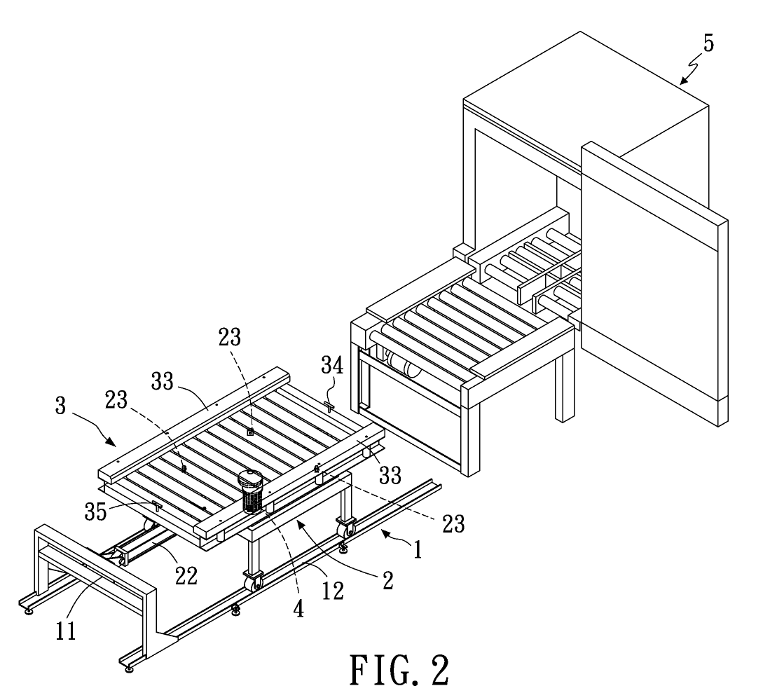

With reference to FIGS. 1 and 2 for an exploded view and a perspective view of a preferred embodiment of the present invention respectively, the auxiliary feed-in mechanism is used to assist an examining mechanism 5 to feed a material. The auxiliary feed-in mechanism comprises a base 1, a driving mechanism 2, a power mechanism 4 and a delivering mechanism 3, wherein the base 1 includes a rail 12 disposed on two sides of the base separately, a crossrod 11 installed on another side of the base 1 and vertically across the two rails 12; the driving mechanism 2 includes a dynamic retractable rod 22 and a chassis 21, and an end of the dynamic retractable rod 22 is pivotally coupled to a front side of the crossrod 11, and another end of the dynamic retractable rod 22 is coupled to a rear side of the chassis 21, and the chassis 21 is movably mounted on the two rails 12; the power mechanism 4 is installed at the bottom of the chassis 21, and a drive shaft 43 of the power mechanism 4 is penetrated through the chassis 21 and then exposed from the top of the chassis 21; and the delivering mechanism 3 includes a frame 31 and a plurality of rollers 32, and the rollers 32 are arranged parallel to one another and pivotally installed in the frame 31, and the delivering mechanism 3 is installed at the top of the chassis 21, and the bottom of the frame 31 is coupled to the drive shaft 43.

The driving mechanism 2 further includes a plurality of rollers 23 pivotally installed at the top of the chassis 21 and around the drive shaft 43, wherein the rollers 23 are rotably contacted with the bottom of the frame 31. The rollers 23 are provided for assisting the drive shaft 43 to support the delivering mechanism 3, so that the delivering mechanism 3 can be rotated stably on the chassis 21.

The delivering mechanism 3 further includes two protective strips 33 and two stop members 34, wherein the two protective strips 33 are installed on both sides of top of the frame 31 respectively and perpendicular to the rollers 32, and the two stop members 34 are movably installed on the other two sides of the top of the frame 31 respectively. The two protective strips 33 can prevent the material to be examined from falling out from the rollers 32 during a transporting process, and the two stop members 34 can prevent the material to be examined from falling out from the roller 32 during the operation of the delivering mechanism 3.

The chassis 21 includes a plurality of sensors 212, 213 installed at the top of the chassis 21. In the figure, a sensor 212, 213 is installed at each diagonal position of the top of the chassis 21 separately, and a sensor 311 is installed at the bottom of the frame 31, and the sensors 212, 213, 311 are coupled to the power mechanism 4. When the power mechanism 4 drives the delivering mechanism 3 to rotate, the sensors 212, 213 installed at the top of the chassis 21 and the sensor 311 installed at the bottom of the frame 31 are induced with each other to control and stop the operation of the power mechanism 4, such that the delivering mechanism 3 can be rotated to a correct angle. When the sensor 311 and the sensor 213 are induced with each other, it indicates that the delivering mechanism 3 is rotated by 180 degrees. When the sensor 311 and the sensor 212 are induced with each other, it indicates that the delivering mechanism 3 is rotated by another 180 degrees. In addition, a sensor can be installed at the top of the chassis 21, and a plurality of sensors are installed at the bottom of the frame 31 to achieve the same effect by the same operating principle as described above.

The power mechanism 4 includes a motor 41 and a gear box 42, wherein the motor 41 is coupled to the gear box 42; the gear box 42 is installed at the bottom of the chassis 21; the drive shaft 43 of the gear box 42 is penetrated through the chassis 21 and exposed from the top of the chassis 21. The motor 41 provides a lower rotating speed and a larger torque to the drive shaft 43 through the gear box 42 to rotate the delivering mechanism 3 stably.

The dynamic retractable rod 22 can be a pneumatic cylinder or a hydraulic cylinder, and an end of the dynamic retractable rod 22 is pivotally coupled to a front side of the crossrod 11, and an end of the retractable rod 221 is coupled to a rear side of the chassis 21.

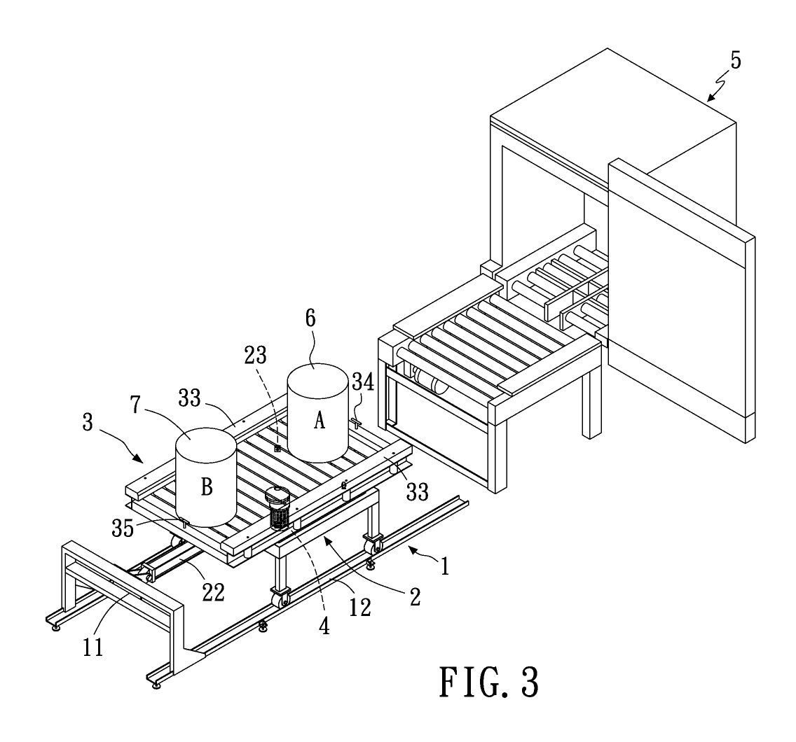

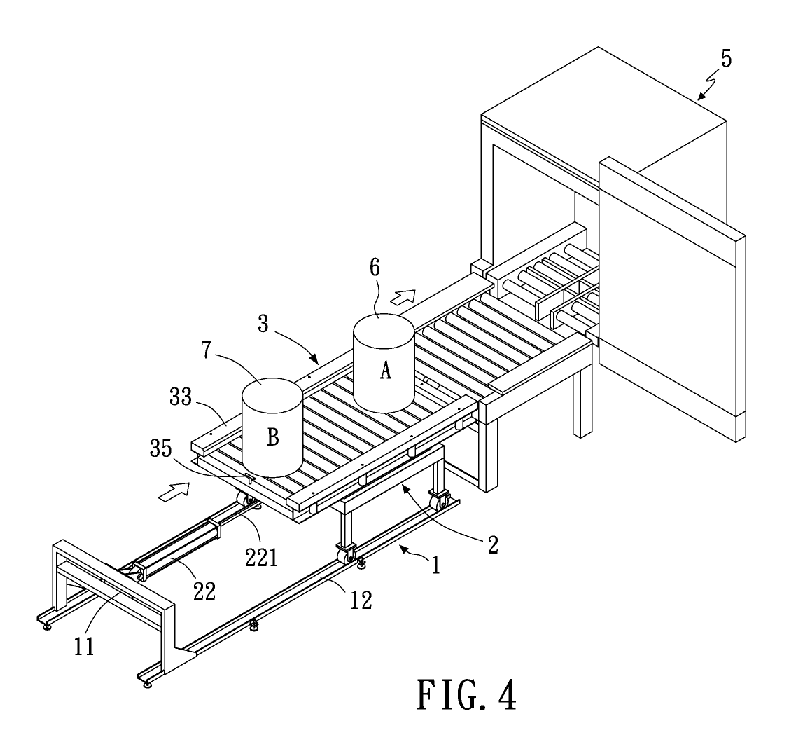

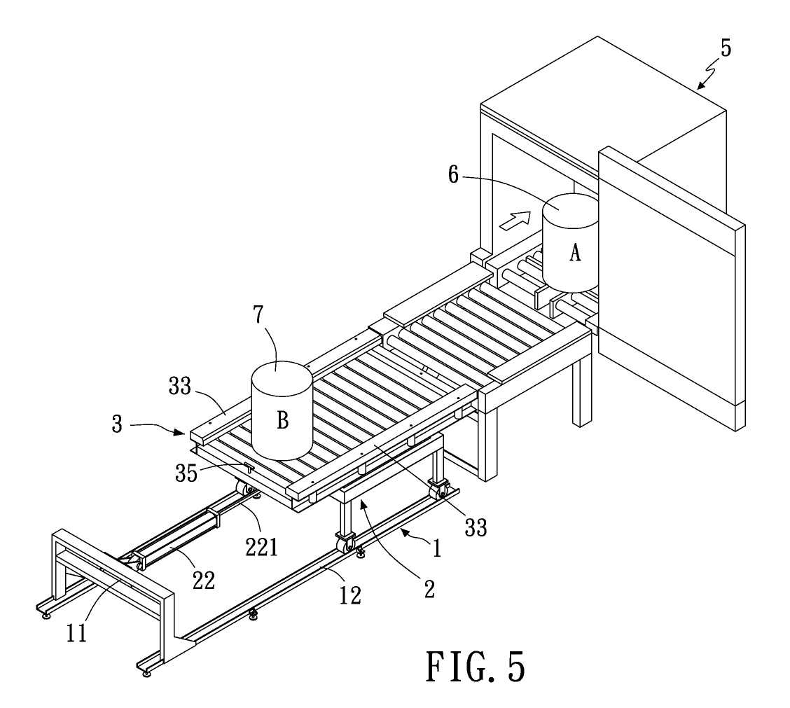

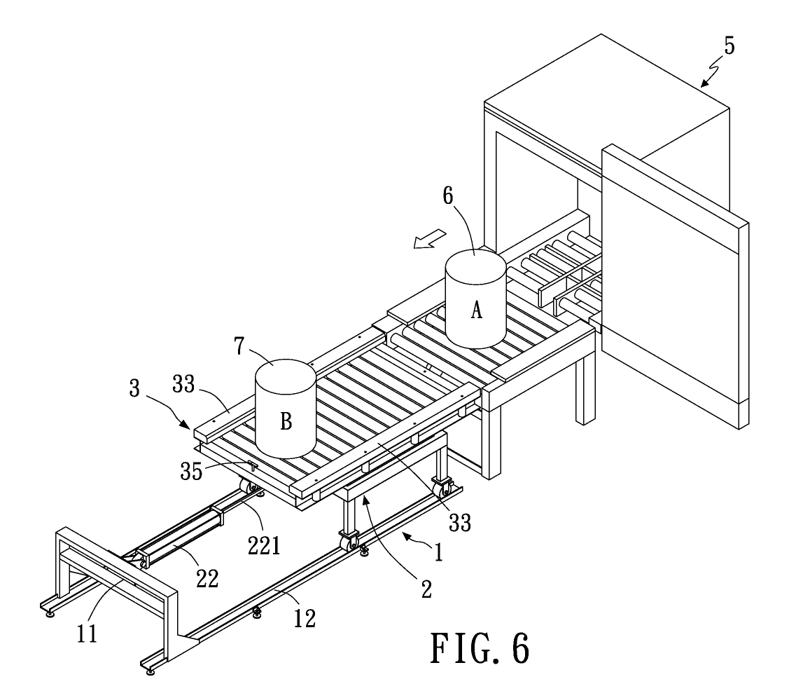

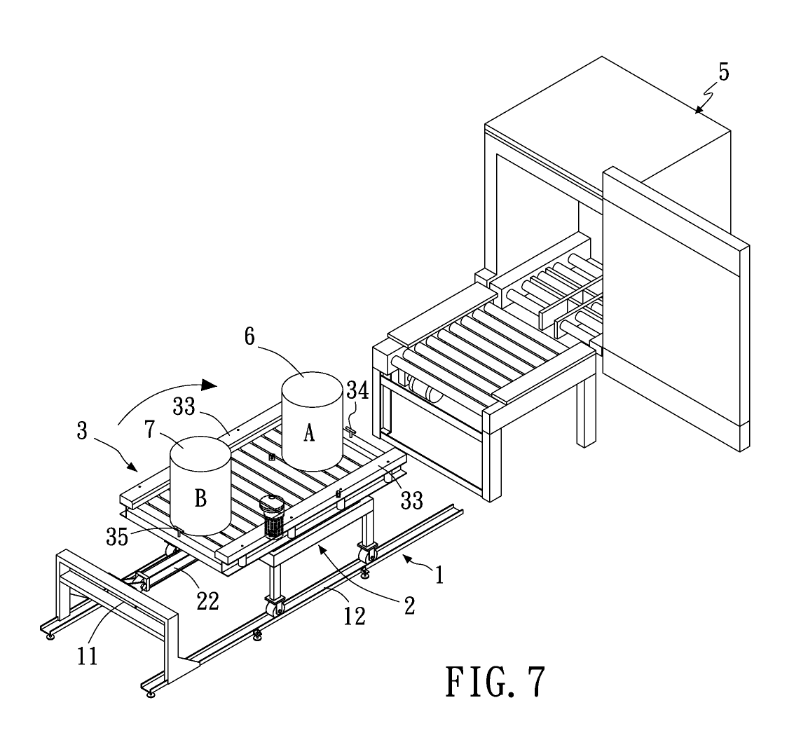

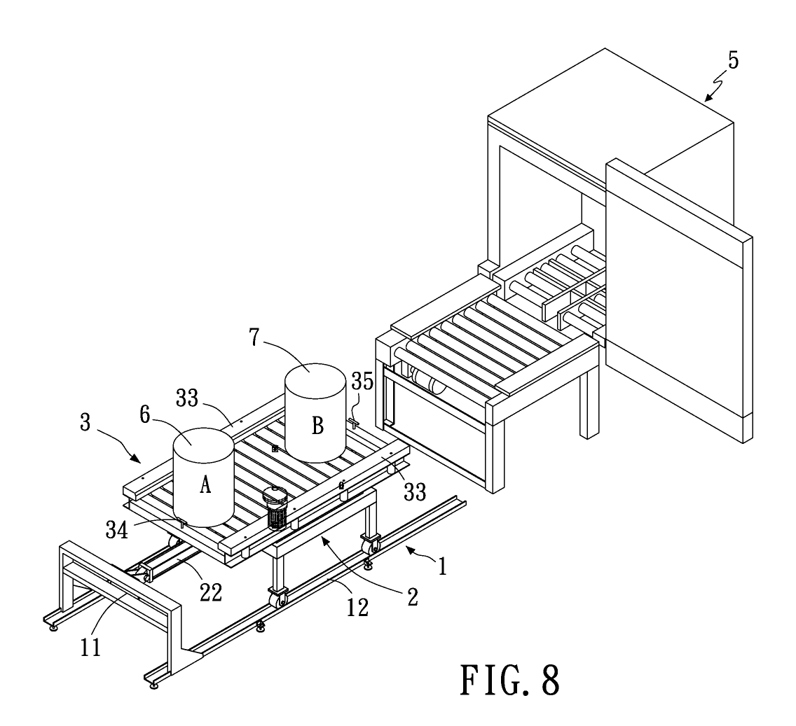

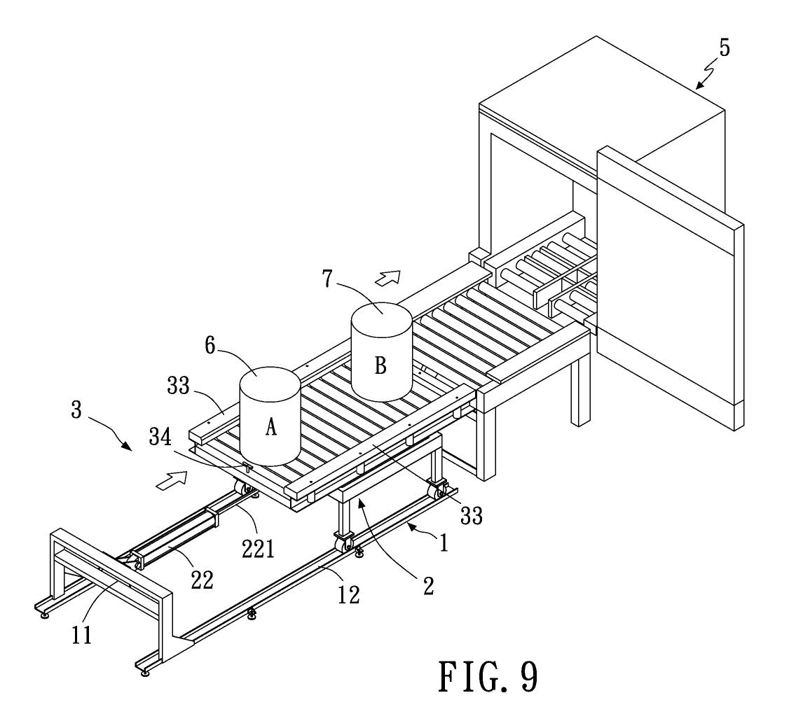

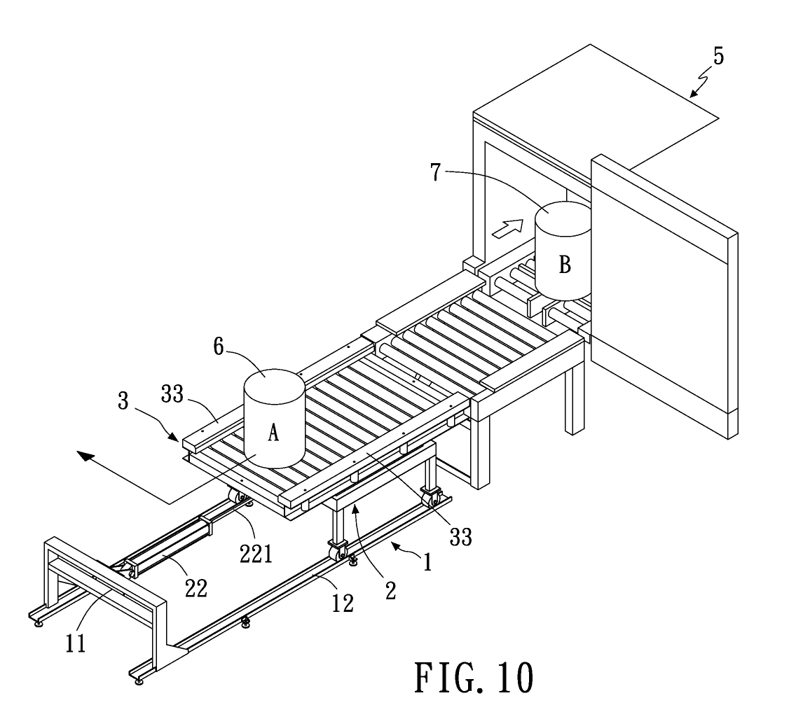

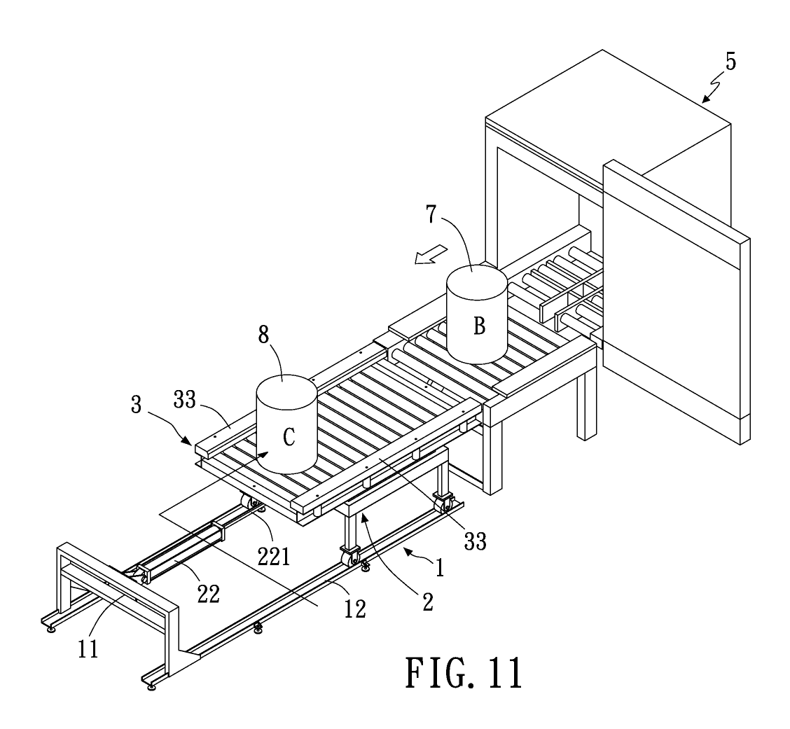

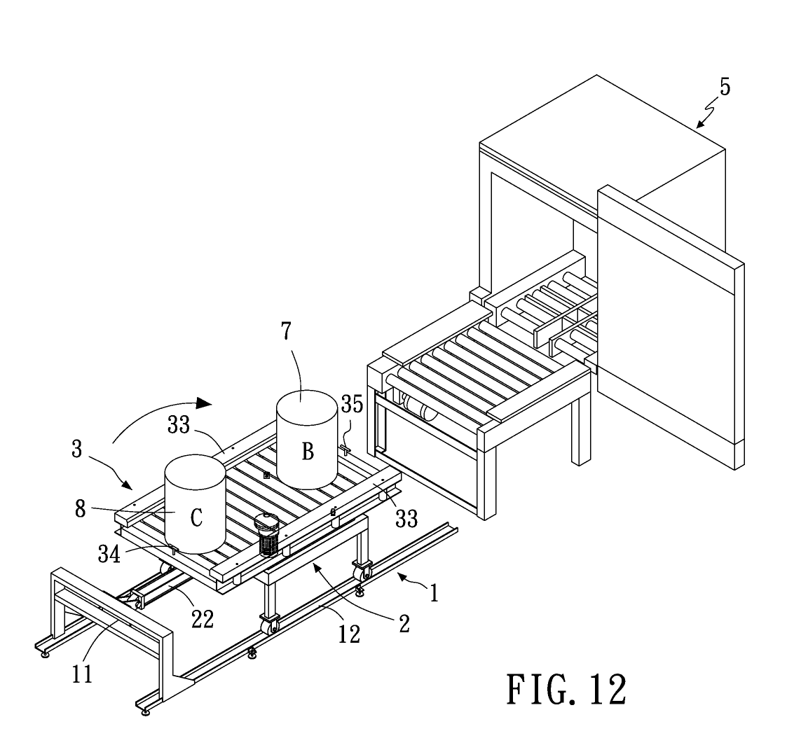

With reference to FIGS. 3 to 12 for the schematic views of an application in accordance with a preferred embodiment of the present invention and FIG. 1 as well, a transporting carrier (such as a forklift) is used to set a first material to be examined 6 and a second material to be examined 7 (such as radioactive solid wastes stored in 55-gallon barrels) on the delivering mechanism 3 during the examination operation in accordance with the present invention, and then the protective strips 33 on two sides of the frame 31 and the stop members 34, 35 on the other two sides of frame 31 are provided for preventing the first and second materials to be inspected 6, 7 from sliding out, and the dynamic retractable rod 22 of the driving mechanism 2 pushes the chassis 21 towards the examining mechanism 5, and a wheel 211 installed at the bottom of the chassis 21 and the rail 12 installed at the bottom of the base 1 are used to move the chassis 21 towards the examining mechanism 5, and then the stop member 34 at an end of the frame 31 is removed, and the first material to be examined 6 is pushed by the operation of the rollers 32 into the examining mechanism 5 for a related examination. After the examination is finished, the first material to be examined 6 is transmitted to an end of the delivering mechanism 3 to resume the stop member 34 to its original position, and then the dynamic retractable rod 22 pulls the chassis 21 back to a predetermined position. The power mechanism 4 is provided to turn the delivering mechanism 3 by 180 degrees. When the sensor 213 installed on another diagonal at the top of the chassis 21 and the sensor 311 installed at the bottom of the frame 31 are induced with each other, the power mechanism 4 can be controlled to stop its rotation, such that the delivering mechanism 3 is rotated by 180 degrees to turn the second material to be examined 7 towards a direction approaching the examining mechanism 5, and then the dynamic retractable rod 22 pushes the chassis 21 towards the examining mechanism 5, and then the stop member 35 on the frame 31 is removed, and the second material to be examined 7 is pushed by the operation of the rollers 32 into the examining mechanism 5 for a related examination. Now, the stop member 34 can be removed in order to transport the first material to be examined 6 by the transporting carrier, and a third material to be examined 8 is placed at the original position of the first material to be examined 6, and then the stop member 34 resumes its original position. After the examination of the second material to be examined 7 is finished, the second material to be examined 7 is transmitted to the delivering mechanism 3 and the stop member 35 resumes its original position, and then the dynamic retractable rod 22 pulls the chassis 21 back to its predetermined position, and the power mechanism 4 turns the delivering mechanism 3 by 180 degrees. The aforementioned steps are repeated to transport each material to be examined in the examining mechanism 5, so as to achieve the effects of increasing the speed of transporting and exchanging the material, reducing the waiting time of the transportation, and improving the examining mechanism of the working efficiency.

In summation of the description above, the present invention provides a delivering mechanism for placing a desired material thereon, such that the delivering mechanism can be operated together with a driving mechanism and a power mechanism to load and unload materials to achieve the effects of increasing the speed of transporting and changing materials, reducing the waiting time during the transportation, and improving the working efficiency of the examining mechanism, and thus the present invention complies with the patent application requirements, and products manufactured in accordance with the present invention can satisfy the current market requirements.

While the invention has been described by means of specific embodiments, numerous modifications and variations could be made thereto by those skilled in the art without departing from the scope and spirit of the invention set forth in the claims.

What is claimed is:

1. An auxiliary feed-in mechanism, for assisting an examining mechanism to feed a material, comprising:
a base, having a rail disposed on two sides of the base separately, and a crossrod installed on another side of the base and across the two rails;
a driving mechanism, having a dynamic retractable rod and a chassis, and an end of the dynamic retractable rod being pivotally coupled to a side of the crossrod, and another end of the dynamic retractable rod being coupled to a side of the chassis, and the chassis being movably mounted on the two rails;
a power mechanism, installed at the bottom of the chassis, and having a drive shaft penetrating through the chassis and being exposed from the top of the chassis; and
a delivering mechanism, having a frame and a plurality of rollers, and the rollers being arranged in parallel with one another and pivotally installed in the frame, and the delivering mechanism being installed at the top of the chassis, and the bottom of the frame being coupled to the drive shaft.

2. The auxiliary feed-in mechanism of claim 1, wherein the driving mechanism further includes a plurality of rollers pivotally installed at the top of the chassis and around the drive shaft, and the rollers are rotably contacted with the bottom of the frame.

3. The auxiliary feed-in mechanism of claim 1, wherein the delivering mechanism further includes two protective strips and two stop members, and the two protective strips are disposed on both sides of the top of the frame respectively and perpendicular to the rollers, and the two stop members are respectively and movably installed on the other two sides of the top of the frame.

4. The auxiliary feed-in mechanism of claim 1, wherein the chassis includes a plurality of sensors installed at the top of the chassis, and a sensor is installed at the bottom of the frame, and the sensors are coupled to the power mechanism.

5. The auxiliary feed-in mechanism of claim 1, wherein the power mechanism includes a motor and a gear box, and the motor is coupled to the gear box, and the gear box is installed at the bottom of the chassis, and the drive shaft of the gear box is penetrated through the chassis and then exposed from the top of the chassis.

6. The auxiliary feed-in mechanism of claim 1, wherein the dynamic retractable rod is a pneumatic cylinder or a hydraulic cylinder.
